(19) United States
(12) Patent Application Publication
(10) Pub. No.: US 2009/0242600 A1
(43) Pub. Date: Oct. 1, 2009

(54) Protective rear accessory bumper with integrated spare tire carrier

(76) Inventors: James M. Helms, N. Fort Myers, FL (US); Mark R. Barie, Glenshaw, PA (US)

Correspondence Address: KAREN TANG-WAI SODINI, 216 horseshoe drive, MARS, PA, 16046, US

(21) Appl. No.: 12/381,917

(22) Filed: Mar. 18, 2009

Related U.S. Application Data
(60) Provisional application No. 61/039,280, filed on Mar. 25, 2008.

(51) Int. Cl. B62D 43/02; B60R 19/48

(52) U.S. Cl. 224/489; 224/503; 224/42.12; 224/533; 293/117

(57) ABSTRACT

A protective rear accessory bumper and integrated spare tire carrier for use on a host land vehicle providing protective features designed to minimize vehicle damage in rear-end vehicular collisions, and also providing rapid access to, and stowage of, a spare tire, by means of a pivoting tire carrier assembly, allowing a single person to change a heavy tire too heavy for the person to lift by hand.

### CROSS REFERENCE TO RELATED APPLICATIONS

Reference is made to and priority claimed from U.S. provisional application Ser. No. 61/039,280, filed on Mar. 25, 2008.

### FIELD OF THE INVENTION

The present invention relates to vehicle bumpers and spare tire storage devices, and more particularly pertains to a rear protective accessory bumper with an integrated spare tire carrier.

### BACKGROUND OF THE INVENTION

The rear bumper area on a vehicle is prone to collision and other damage due to its location. Additionally, spare tire storage on motorized vehicles can make the process of loading and unloading a heavy tire cumbersome and inconvenient. In particular, the tires used for some military vehicles can weigh over 300 pounds, and hence changing these tires can be difficult for a single person.

It would be advantageous to combine the properties of a protective bumper minimizing collision damage to a host vehicle with easy storage and retrieval of a spare tire.

### SUMMARY OF THE INVENTION

The present invention provides a new protective rear accessory bumper designed to minimize collision damage to a host vehicle, and further for facilitating stowage of, and rapid access to, a spare tire via an integrated spare tire carrier. The integrated spare tire carrier allows a single person to change a heavy tire too heavy to lift by hand.

### BRIEF DESCRIPTION OF THE DRAWINGS

The invention will be better understood and objects other than those set forth above will become apparent when consideration is given to the following detailed description thereof. The description makes reference to the annexed drawings wherein:

FIG. 1 is a front view of a protective rear accessory bumper and integrated spare tire carrier according to the invention, shown in stowed position.

FIG. 2 is a perspective view of a protective rear accessory bumper and integrated spare tire carrier according to the invention, shown with the carrier assembly pivoted 90 degrees from the stowed position, with the pivot arm in the upward (stowed) position.

FIG. 3 is a side view showing the carrier assembly pivoted 180 degrees from the stowed position, with the pivot arm in the downward (deployed) position, and illustrating that the orientation of the spare tire relative to the carrier assembly does not change as the arm is pivoted downwards.

FIG. 4 is a front view of the protective rear accessory bumper and integrated spare tire carrier according to the invention, shown in the stowed position.

FIG. 5 is a perspective view of a new protective rear accessory bumper and integrated spare tire carrier according to the invention, shown with the carrier assembly pivoted 90 degrees from the stowed position, with the pivot arm in the upward (stowed) position.

### DRAWINGS LIST OF REFERENCE NUMERALS

The following is a list of reference labels used in the drawings to label components of different embodiments of the invention, and the names of the indicated components.

300 spare tire

301 holding mast

302 neon flash tube strobe light

304 pivot arm

306 cable

307 cross bar for ladder arm

307a hole for inserting lock pin or hitch pin

308 stop

310 locking wing nut

312 threaded shaft

314 motor

316 second or raise-lower swivel hinge

318 bolt holes per bolt pattern for OEM bumper

320 lock pin or hitch pin

322 “fair lead” or four roller winch face

400 rear bumper assembly

402 frame

402a tire carrier assembly attachment point

404 striking surface

406 tire carrier assembly

408 first or out-back swivel hinge

410 horizontal support member

412 vertical pivot member

414 searchlight

416 latch

500 rear bumper with integrated spare tire carrier

### DETAILED DESCRIPTION

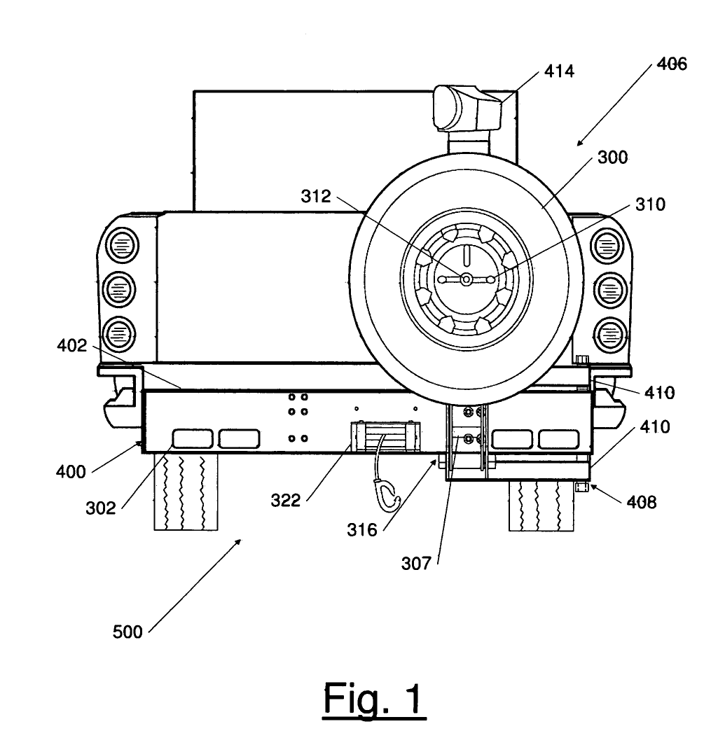

Referring to FIGS. 1-5, a protective rear accessory bumper with an integrated spare tire carrier 500 includes a rear bumper assembly 400 and an integrated spare tire carrier assembly 406. The rear bumper assembly is a shock absorbing bumper structure—e.g. a weldment, casting, or extrusion-adapted to removably couple to the frame of a host land vehicle, and the deployable tire carrier structure 406 is pivotably attached to the bumper structure for providing mechanical advantage in loading and unloading a spare tire. The invention may also feature an opening to accommodate guide rollers for a winch, and a searchlight or other optional lighting component.

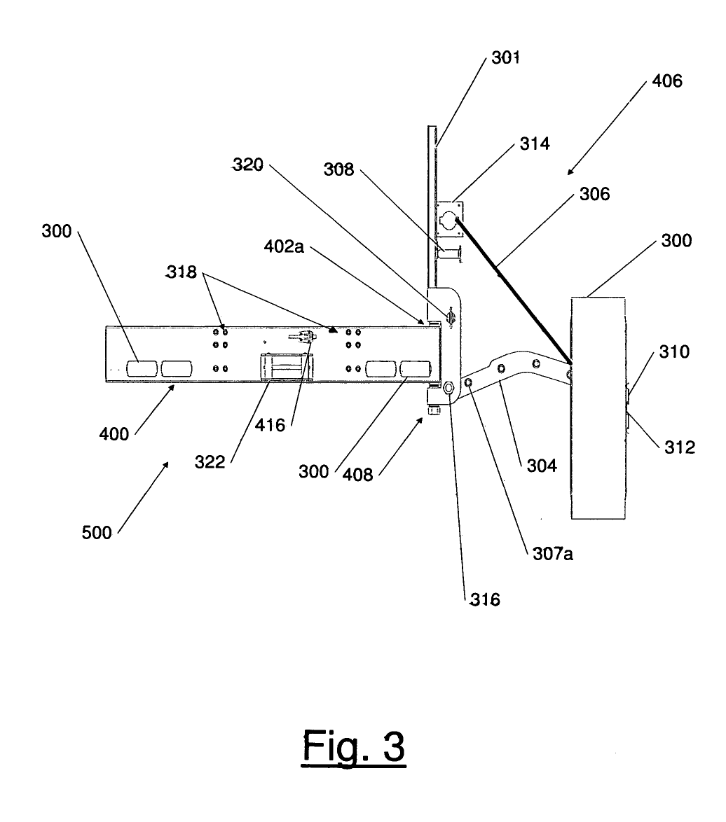

As best illustrated in FIGS. 3 & 4, the rear accessory bumper assembly 400 generally comprises a two-ended protective frame element 402 having at least one striking surface 404. The frame 402 may be a c-channel weldment or other structure (e.g. a casting or an extrusion), or any other suitable weldment or other structure shaped so as to roughly conform to the rear profile of the host vehicle. The frame 402 may have at least one removable or non-removable attached light or strobe light, such as a neon flash tube strobe light 302 applied to, or recessed within, the at least one striking surface 404. The striking surface 404 may include a plurality of bolt holes 318 corresponding to the hole pattern found in host vehicle's OEM (Original Equipment Manufacturer) rear bumper.

The rear accessory bumper assembly 400 may further provide an opening configured to accommodate guide rollers for a winch 322 having at least one winch roller and a winch motor, centrally located on the frame 402 so as to allow winching from the striking surface 404. The winch may be a “fair lead” winch having four rollers, and the winch motor may be mounted to the interior of the frame 402 facing the host vehicle. A controller (not separately shown) for operation of the winch plugs into an outlet (not separately shown) on the back of the host vehicle.

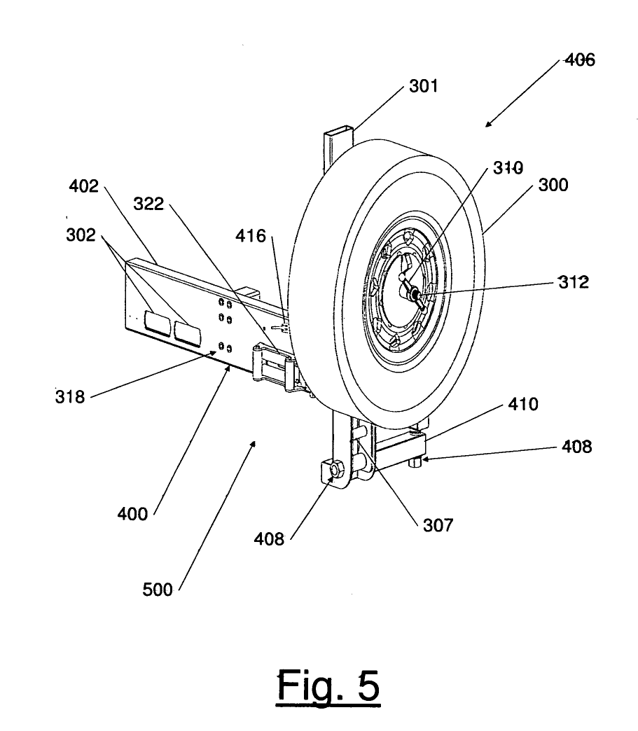

As shown more particularly in FIGS. 3, 4 and 5, the rear accessory bumper with integrated spare tire carrier 500 further comprises a tire carrier assembly 406 pivotably attached to the frame 402 by a first or out-back swivel hinge 408 at an attachment point 402a. The out-back swivel hinge 408 may include a vertical pivot member 412 pivotably attached to and extending through either end of the frame 402. As shown more particularly in FIG. 3, a lock pin or a hitch pin 320 is inserted into a hole 307a created by a hollow cylindrical cross member 307 in the pivot arm 304, and is used to secure the tire carrier assembly in an upright position, with a retainer pin (not shown) securing the hitch pin 320. The hitch pin 320, in the embodiment shown, consists of a one-inch diameter, solid steel cylindrical pin pierced by a hole at one end, and through which the retainer pin is inserted, however any suitable fastening means, including screws, pins and clamp fasteners may be used to secure the assembly 406. As shown more particularly in FIGS. 3 and 5, a latch 416 located on the bumper striking surface 404 holds the tire carrier assembly 406 in place for transit.

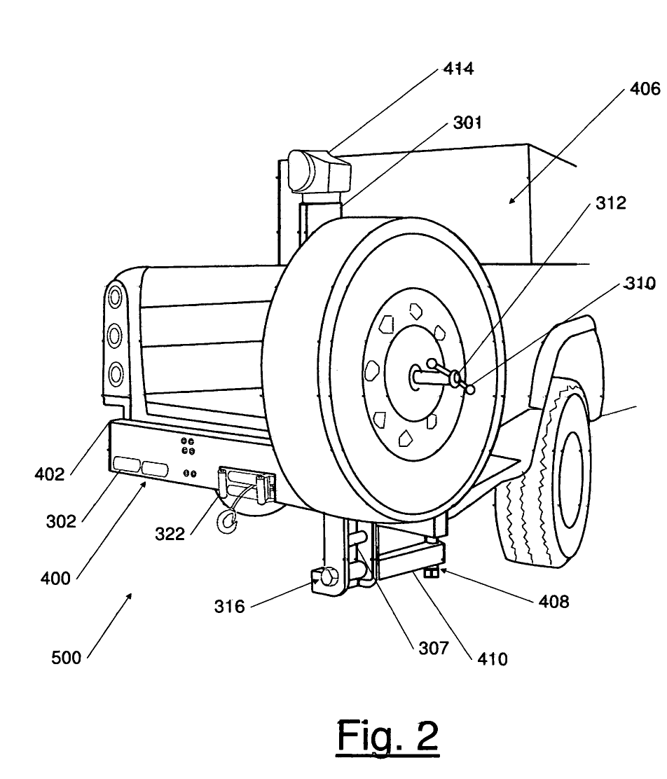

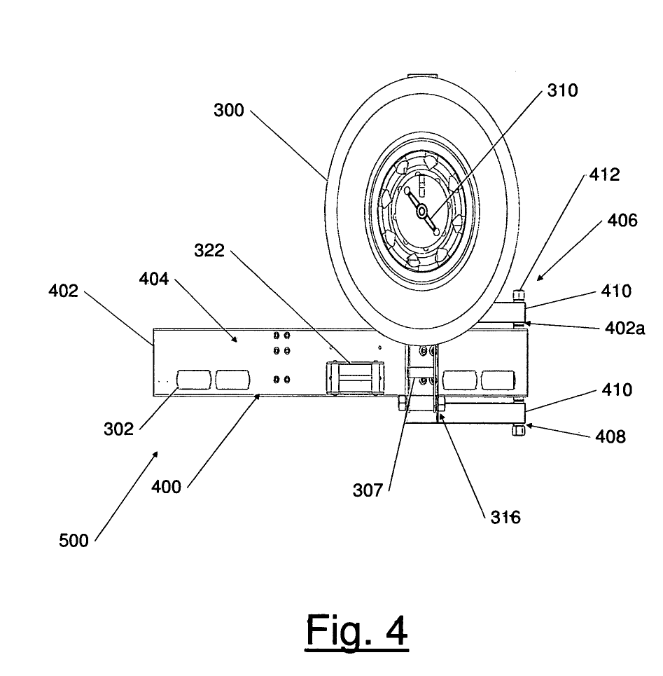

The tire carrier assembly 406 may further comprise a holding mast 301 fixedly attached to the frame 402 and in some embodiments, to a distal end of at least one horizontal support member 410. As shown more particularly in FIG. 3, a pivot arm 304 is pivotably attached to the frame 402 and in some embodiments, as shown in FIGS. 4 and 5, to the at least one support member 410 by a second or raise-lower swivel hinge 316, so that when the arm is in a transit or “back” or stowed position, the pivot arm 304 abuts or nearly abuts the holding mast 301. The pivot arm may be any type of arm, but a ladder-type arm having at least one ladder cross member 307 is preferred. A searchlight 414, as shown in FIGS. 1 and 2, may also be attached to the top of the holding mast 301 by means of an adaptor plate (not shown).

As shown more particularly in FIG. 3, a motor 314 may be used to control tension on a cable 306 used for raising and lowering the pivot arm 304 when a spare tire is present. Preferably, the motor 314 drives a spool (not separately shown) about which the cable 306 may be wound and unwound, so as to affect movement of the pivot arm 304. The motor may be any suitable motor, such as an electric motor driven by the host vehicle's internal power supply. To prevent motor damage, an electric stop 308 including a limit switch able to sense the travel distance of the assembly 406, may be attached to the holding mast 301 to limit upward travel of the pivot arm 304.

As shown more particularly in FIGS. 3 and 5, a spare tire 300 is connected to the pivot arm 304 by a threaded shaft 312. The shaft 312 itself is pivotably attached (not shown) to the pivot arm 304 and this pivoting attachment allows the spare tire to consistently remain in an upright, level position, regardless of the position of the pivot arm 304. Gravity keeps the spare tire level as the tire assembly 406 is deployed. The tire in the embodiments shown in FIGS. 3-4 is secured to the shaft 312 a locking wing nut 310, but any appropriate securing means can be used.

In operation, the tire carrier assembly 406 is designed to swivel outward from the vehicle and then the motor lowers or raises the spare tire to minimize or eliminate any heavy lifting that would otherwise be necessary. It should be noted that the tire assembly 406 may also be deployed without swiveling the assembly 406 away from the vehicle. The swiveling feature allows the vehicle tailgate to be opened at the same time the assembly 406 is deployed. The bumper assembly 400 may be provided as an original bumper for the host vehicle or as a replacement bumper and is installed in the same fashion and with the same fastening means as an original host vehicle bumper.

The protective rear accessory bumper and tire carrier 500 may be constructed from aluminum, steel, titanium, composites, or any other suitable material able to support sheer stress. Preferably, the protective rear accessory bumper should substantially extend across the rear of the host vehicle so as to provide protection in the event of a rear-end collision. The protective rear accessory bumper is designed so as to complement the host vehicle design, and can preferably be used to replace the original equipment manufacturer (OEM) bumper, but can also be used in addition to the OEM bumper. The bumper assembly 400 is particularly suited for use on utility vehicles, such as the International MXT® utility truck, the HMMWV (High Mobility Multipurpose Wheeled Vehicle) used by the US Military and also variants for sale commercially, including the so-called Hummer and H2, available from AM General.

With respect to the above description, it is to be realized that the optimum dimensional relationships for the parts of the invention to include variations in form, shape, size, use, function, assembly, materials, and manner of operation, are deemed readily apparent and obvious to one skilled in the art, and all equivalent relationships to those illustrated in the drawings and described in the specification are intended to be encompassed by the present invention. The phraseology and terminology employed herein are for the purpose of description and should not be regarded as limiting. Therefore, the foregoing is considered as illustrative only of the principles of the invention.

What is claimed is:

1. An accessory bumper with an integrated spare tire carrier assembly for use on a posterior side of a host land vehicle, comprising:
a bumper assembly (400) comprising a two-ended protective frame element (402) having an attachment point (402a) at one end through which a holding mast (301) having a first end, extends through the frame element (402) and pivotably attaches to a first swivel hinge (408); and
a deployable tire carrier assembly (406) including a pivot arm (304) having a first end and a second end, the second end of the pivot arm for pivotably attaching to a spare tire (300) via a shaft (312), and the first end of the pivot arm penetrated by the holding mast (301) at the attachment point (402a), and a second swivel hinge (316) connected to the first end of the holding mast (301) and to the first end of the pivot arm (304) at the attachment point (402a), whereby the tire carrier can pivot away from the host vehicle via the first swivel hinge (408) and the spare tire (300) can be raised or lowered via the second swivel hinge (316); and
fastening means (320, 416) for securing the tire carrier assembly (406) in an upright position.

2. The accessory bumper of claim 1, wherein the deployable tire carrier assembly (406) is pivotably attached to the first swivel hinge (408) by at least one horizontal support member (410) having two ends, the first end of the at least one horizontal support member connected to the first swivel hinge (408), and the second end of the at least one horizontal support member connected to a first end of a vertical holding mast (301) having two ends, a second swivel hinge (316) connected to the first end of vertical holding mast (301), a first end of a pivot arm (304) having two ends attached to the second swivel hinge (316).

3. The accessory bumper of claim 1, wherein the deployable tire carrier assembly (406) includes a motor (314) for adjusting tension on a cable (306) connected to a second end of the pivot arm (304).

4. The accessory bumper of claim 1, wherein the deployable tire carrier assembly (406) includes features by which the spare tire carrier assembly (406) can be secured in an upright position by a hitch pin (320) and a retainer pin.

5. The accessory bumper of claim 1, wherein the deployable tire carrier assembly (406) includes an electric stop (308) connected to the holding mast for limiting upward travel of the pivot arm.

6. The accessory bumper of claim 1, wherein the two-ended protective frame element (402) is a c-channel weldment.

7. The accessory bumper of claim 1, wherein the fastening means for securing the tire carrier assembly (406) in an upright position locks the tire carrier assembly (406) against the bumper assembly (400), and comprises a latch (416) mounted to a striking face (404) of the bumper assembly (400) and aligned so that when the tire carrier assembly (406) is pushed against the latch (416), the tire carrier assembly (406) locks in place and is prevented from swinging freely.

8. The accessory bumper of claim 1, wherein the fastening means for securing the tire carrier assembly (406) in an upright position locks the tire carrier assembly (406) in an upright position and comprises a hitch pin (320) having an end with a hole, the hitch pin (320) being inserted into a hole (307a) created by a hollow cross section of a ladder arm (307) in the pivot arm (304) and a retainer pin threaded through the hole of the hitch pin.
